(19) United States
(12) Patent Application Publication
(10) Pub. No.: US 2019/0303421 A1
(43) Pub. Date: Oct. 3, 2019

(54) HISTOGRAM SKETCHING FOR TIME-SERIES DATA

(71) Applicant: CA, Inc., New York, NY (US)

(72) Inventor: Christopher Phillip Bonnell, Longmont, CO (US)

(21) Appl. No.: 15/942,690

(22) Filed: Apr. 2, 2018

(51) Int. Cl. G06F 17/18; G06F 17/30

(52) U.S. Cl. CPC G06F 17/18; G06F 17/30949; G06F 17/30979

(57) ABSTRACT

The developed histogram sketching technology transforms a time-series dataset having d dimensions and a number of time instants (S) in the time-series dataset into different numbers of histogram registers per dataset dimension for each variable for which value distribution is to be tracked. The histogram sketching technology selects the numbers of histogram registers per dataset dimension based on the Chinese Remainder Theorem. The numbers of histogram registers per dataset dimension are co-prime numbers that are each near a d^{th} root of S and the product of these co-prime numbers is greater than S. Thus, the S time slices are being compressed into different numbers of histogram registers that allow for reconstruction of a time slice based on the Chinese Remainder Theorem.

### BACKGROUND

The disclosure generally relates to the field of data processing, and more particularly to database and file management or data structures.

Obtaining exact answers to basic queries on streaming data and/or massive datasets (e.g., petabytes and larger) consumes large amounts of compute resources. In addition, a query on a massive dataset (“Big Data”) can require an amount of time that becomes unacceptable for analysis.

Stochastic stream algorithms have been developed to address the challenges of querying streaming data and/or massive datasets for cases in which approximate answers are acceptable. These algorithms process a massive dataset in a single pass, and compute small summaries of the dataset. Accurate, approximate answers to queries for the massive dataset can be provided with these summaries. The data processing performed by the algorithms is referred to as “sketching” and the associated data structures as “sketches.” The terminology is an allusion to an artist's sketch. Sketching contrasts with traditional sampling techniques in that sketching processes each datum of a data stream once and leverages some form of randomization that forms the basis of its stochastic nature. When queried, the sketches are accessed and an approximate result to the query will be generated that will have a mathematically proven error distribution bounds.

Although multiple algorithms exist, some common attributes are the small sketches generated, the speed of the algorithms, and configurable approximation. Sketches are typically orders of magnitude smaller than the raw input data. Sketching implements sublinear algorithms that grow in size slower than the size of the input data. Some sketches have a finite upper-bound in size that is independent of the size of the input data. Sketching typically involves a single pass or one touch of the input data and the update times are independent of the size or order of the input data. With respect to approximation, sketch size is a configuration parameter that influences the relative error bounds.

### BRIEF DESCRIPTION OF THE DRAWINGS

Embodiments of the disclosure may be better understood by referencing the accompanying drawings.

FIG. 1 is a conceptual diagram of a time-series histogram sketcher transforming a time-series dataset into histogram sketches.

FIG. 2 is a conceptual diagram of a time-series histogram minimum approximate query processor generating an approximate answer to a query with the example time-series dataset of FIG. 1.

FIG. 3 is a flowchart of example operations for recording a time-series dataset into time-series histogram sketches.

FIG. 4 is a flowchart of example operations for constructing an approximate answer to a query with time-series histogram sketches.

FIG. 5 depicts an example computer system with a time-series histogram sketcher and a time-series histogram approximate query processor.

### DESCRIPTION

The description that follows includes example systems, methods, techniques, and program flows corresponding to embodiments of the disclosure. However, it is understood that this disclosure may be practiced without these specific details. In other instances, well-known instruction instances, protocols, structures and techniques have not been shown in detail in order not to obfuscate the description.

### Terminology

This description uses a term “histogram” to refer to a data structure used to track distribution of values for a variable. A variety of implementations are available for a histogram data structure and can include program code or instructions that control access of the histogram data structure. The number of bins can be static or dynamic based upon the variable being tracked. For example, embodiments may use a high dynamic range histogram or sparse version thereof.

The description uses a term “histogram register” to refer to a collection of histograms with a common attribute(s). In this description, the common attributes for a collection of histograms identified as a histogram register are a same dataset attribute and a same time based mapping value. A histogram register can be implemented with one or multiple data structures associated with a value(s) that corresponds to the common attribute(s).

The description also uses the term “histogram register set” and “histogram sketches” to refer to a set of histogram registers that summarize distribution of data values for a tracked variable. In the example illustrations below, a histogram register set or set of histogram sketches are maintained per attribute. Thus, a histogram sketch and a histogram register can be considered synonymous.

Overview

In some technologies that involve massive datasets, query answers that are accurate but approximate can still have high value for analysis. For instance, application performance management tools continuously produce large amounts of time-series data that are analyzed in subsets of the produced data. The dynamic nature of applications and numerous attributes of the data inhibit the utility of computing pre-determined sub-combinations of the attributes for analysis. However, without computing pre-determined sub-combinations of the attributes of a massive dataset a query cannot be answered in a reasonable amount of time and without consuming vast computing resources.

A sketching technology has been developed that can efficiently transform a massive time-series dataset, whether fixed or streaming, into histogram sketches that track value distributions for multiple variables across multiple attributes of the dataset. The transformation can reduce a dataset's petabytes footprint to histogram sketches with a combined footprint in gigabytes. An approximate query processor can then access the histogram sketches to quickly provide an accurate, approximate answer to a query that specifies any combination of attributes for a tracked variable at a particular time slice of the dataset or across multiple time slices. The approximate query answer will be a reconstruction of an approximation of each specified time slice because this sketching technology allows time slices to share histograms in the histogram sketches.

The developed histogram sketching technology transforms a time-series dataset having d attributes and a number of time instants (S) in (or expected to be in) the time-series dataset into different numbers of histogram registers per dataset attribute for each variable for which distribution is to be tracked. The histogram sketching technology selects the numbers of histogram registers per dataset attribute based on the Chinese Remainder Theorem. The numbers of histogram registers per dataset attribute are co-prime numbers that are each near a d^{th} root of S and the product of these co-prime numbers is greater than S. Thus, the S time slices are being compressed into different numbers of histogram registers that allow for reconstruction of a time slice based on the Chinese Remainder Theorem.

Example Illustrations

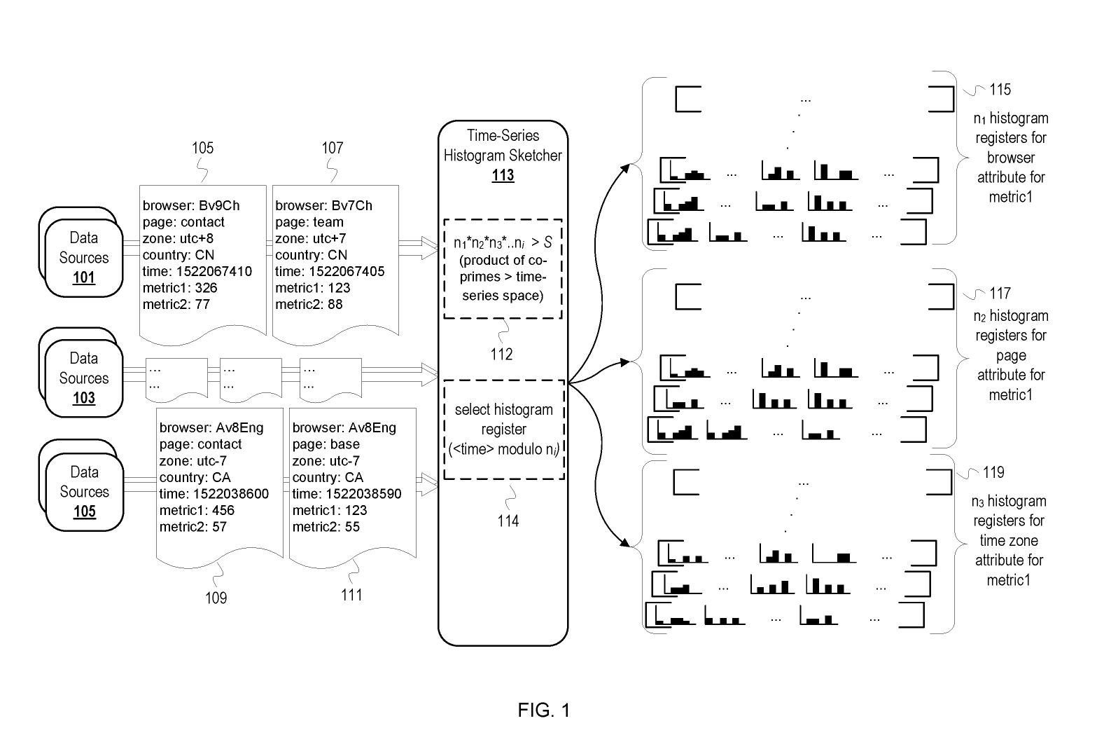

FIG. 1 is a conceptual diagram of a time-series histogram sketcher transforming a time-series dataset into histogram sketches. This example illustrations depicts the time-series dataset as streaming performance data collected for a web page application. The dataset identifies several attributes of the time-series application performance data that include web browser, web page name, time zone, country from which the page was accessed, and a timestamp. The collected performance data includes two example variables collected from the application—a metric1 and a metric2.

FIG. 1 depicts multiple data sources 101, 103, 105 streaming the application performance data to a time-series histogram sketcher 113. The data sources 101 are communicating a time-series data stream that includes a datum 105 and a datum 107, each corresponding to a different time slice as indicated by the different time values or time. The datums 105, 107 include different data values for the browser, page, and time zone attributes. The datums 105, 107 and include a same data value for the country attribute. The data sources 105 are communicating a time-series data stream that includes a datum 109 and a datum 111. Each of these also correspond to a different time slice as with datum 105, 107, although there can be cases of datums from different data sources being at same time slices or time instants. The datums 109, 111 include different data values for the page attribute, and same data values for the browser, time zone, country attributes.

The time-series histogram sketcher (“sketcher”) 113 updates a set of histogram registers for the time-series dataset based on the Chinese Remainder Theorem. Prior to receiving data, the sketcher 113 determines co-prime numbers for the dataset attributes of the dataset. The sketcher 113 chooses the co-prime numbers (n₁, n₂, . . . , nᵢ) to be near the i^{th} root of the space (S) of the time-series dataset and to have a product that is greater than the space of the time-series dataset. These conditions on the co-prime numbers is depicted in the dashed box 112. Since collection of the application performance data is ongoing, the space of the time-series dataset can be chosen as a maximum desired time span for analysis. For example, the space will be a maximum time span of 1 year divided by the collection interval of 7 seconds, which can be rounded to the nearest integer of 4,508,229 time slices using 365.25 days for a year. The number of time slices will likely be substantially larger with data collection intervals of a second or smaller. Using this example of 4 dataset attributes and 4,508,229 time slices, the sketcher 113 would find 4 co-prime numbers that are near the 4^{th} root of 4,508,229. The sketcher 113 can compute the 4^{th} root of 4,508,229 and round to the integer 46. This can be used as a starting value to search for the other co-prime numbers. The sketcher 113 can search in both directions from 46 or only greater numbers. When searching greater numbers, the sketcher 113 can search incrementally to avoid unnecessarily large co-prime numbers. The sketcher 113 may choose 45, 47, and 49 as the other co-prime numbers. The sketcher verifies that the product of the chosen co-prime numbers is greater than 4,508,229 (45*46*47*49=4,767,210).

The sketcher 113 then determines which of the determined co-prime numbers 45, 46, 47, 49 to associate with which dataset attribute. Embodiments can make this determination arbitrarily or deterministically, such as based on characteristics of the dataset attributes or descriptions of the dataset. As examples, this determination can be based on order of appearance of the dataset attributes in a schema, metadata, or datum descriptor. The co-prime numbers indicate a number of histogram registers for the dataset attributes. Continuing with the example numbers, the sketcher 113 instantiates 45 histogram registers for the browser attribute, 46 histogram registers for the page attribute, 47 histogram registers for the time zone attribute, and 46 histogram registers for the country attribute. Thus 4,767,210 time slices can be approximately reconstructed with the 45-49 histogram registers across the dataset attributes per tracked variable. Due to limited drawing space, FIG. 1 only depicts histogram registers for three of the four example dataset attributes and only for the tracked variable metric1. So, the remaining description does not describe accessing a histogram register set for the dataset attribute country although the sketcher 113 would. Figure illustrates a histogram register set 115 with n₁ histogram registers for the browser attribute for metric1, a histogram register set 117 with n₂ histogram registers for the page attribute for metric1, and a histogram register set 119 with n₃ histogram registers for the time zone attribute for metric1. Embodiments can instantiate complete histogram register sets with empty histogram structures prior to receipt of data, can instantiate partial histogram register sets with empty histogram structures prior to receipt of data, or can instantiate histogram registers as initial datums are received/retrieved.

Based on receipt of each datum, the sketcher 113 will update the appropriate histogram within an appropriate histogram register set to track the data values assigned to the tracked variables in each datum. To identify the histogram register in each attribute's histogram register set, the sketcher 113 applies the selection operation depicted in dashed box 114: <time> modulo nᵢ. For the datum 111, the sketcher 113 identifies a histogram register within each of the histogram register sets 115, 117, 119. The sketcher 113 selects a histogram register within the histogram register set 115 that maps to 1522038590 modulo 45=35. This is the determination that the time slice corresponding to the time value 1522038590 is represented by the histogram register indexed by 35 within the histogram register set 115. Within the histogram register that maps to 35 within the histogram register set 115, the sketcher 113 selects a histogram that maps to a hash value generated from the browser attribute value “Av8Eng.” In this example, “Av8Eng” indicates version 8 of a browser A for English. The sketcher 113 then updates a bin within the selected histogram that corresponds to the metric1 value “123.”

The sketcher 113 performs similar operations for each attribute of each datum. Continuing with the datum 111, the sketcher 113 selects a histogram register within the histogram register set 117 that maps to 1522038590 modulo 46=20. Within the histogram register set 117, the time slice corresponding to the time value 1522038590 is represented by the histogram register indexed by 20. Within the histogram register that maps to 20 within the histogram register set 117, the sketcher 113 selects a histogram that maps to a hash value generated from the page attribute value “base,” and updates the bin that corresponds to the metric1 variable data value “123.” For the time zone attribute, the sketcher 113 selects a histogram register within the histogram register set 119 that maps to 1522038590 modulo 47=37. Within the histogram register that maps to 37 within the histogram register set 119, the sketcher 113 selects a histogram that maps to a hash value generated from the time zone attribute value “utc-7,” and updates the bin that corresponds to the metric1 variable data value “123.” Table 1 below identifies the histogram and histogram register selected for each time slice corresponding to the other illustrated datums 105, 107, 109. Although these examples use a unix timestamp, implementations will likely normalize or scale the time values relative to a starting point for the time instant.

TABLE 1
Selected Histograms and Histogram Registers
within Each Attribute Histogram Register Set

| | Browser Histogram | Page Histogram | Time Zone |
|---|---|---|---|
| Datum | Register Set for | Register Set for | Histogram Register |
| Time | Metric1 | Metric1 | Set for Metric1 |
| 1522038600 | Histogram that maps to | Histogram that maps | Histogram that maps |
| | Hash1(Av8Eng) within | to Hash2(contact) | to Hash3(utc − 7) |
| | the histogram register | within the histogram | within the histogram |
| | that maps to 0 | register that maps to | register that maps to |
| | | 30 | 0 |
| 1522067405 | Histogram that maps to | Histogram that maps | Histogram that maps |
| | Hash1(Bv7Ch) within | to Hash2(team) | to Hash3(utc + 7) |
| | the histogram register | within the histogram | within the histogram |
| | that maps to 5 | register that maps to | register that maps to |
| | | 39 | 41 |
| 1522067410 | Histogram that maps to | Histogram that maps | Histogram that maps |
| | Hash1(Bv9Ch) within | to Hash2(contact) | to Hash3(utc + 8) |
| | the histogram register | within the histogram | within the histogram |
| | that maps to 10 | register that maps to 44 | register that maps to |
| | | | 46 |

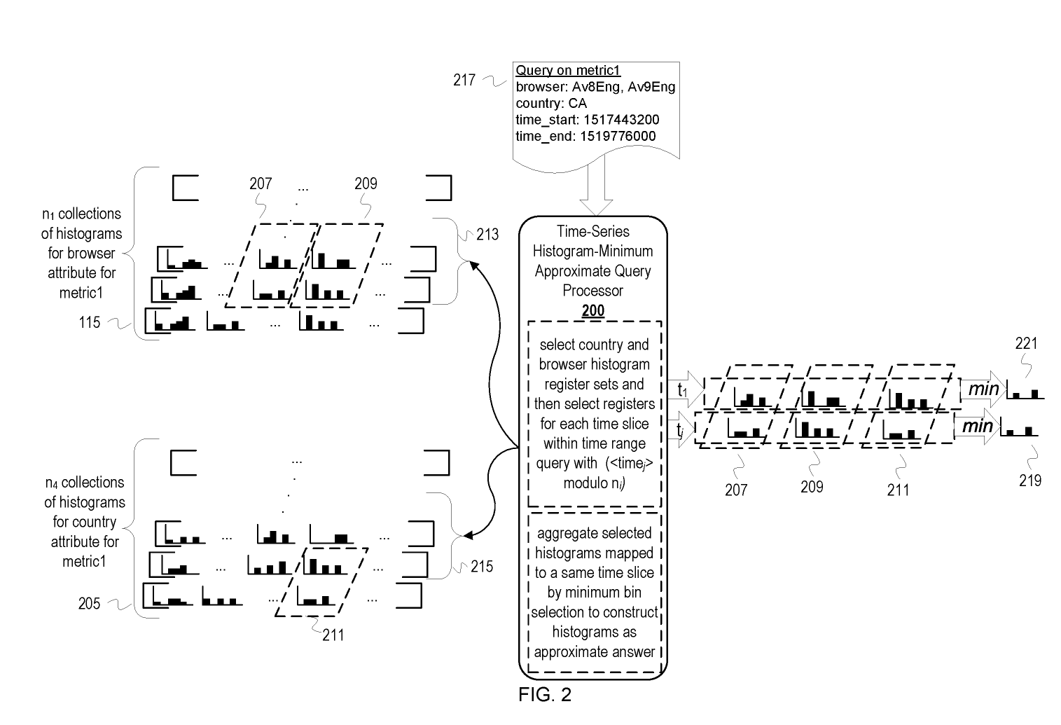

FIG. 2 is a conceptual diagram of a time-series histogram minimum approximate query processor generating an approximate answer to a query with the example time-series dataset of FIG. 1. A time-series histogram-minimum approximate query processor (“AQP”) 200 accesses a histogram sketches generated by the sketcher 113 to answer a query about the time-series data set that has been sketched. Although not depicted in FIG. 1, FIG. 2 depicts a histogram register set 205 for the country attribute of the time-series dataset. The histogram register set 205 has/can have n₄ histogram registers for the time span of the time-series dataset. The AQP 200 will access histogram register sets based on a query and apply a minimum operation to construct an answer to the query based on the retrieved histograms by the time parameter in the query.

In FIG. 2, the AQP 200 detects a query 217 on the tracked variable metric1. The query 217 indicates “CA” as the country and two browsers for the browser attribute: “Av8Eng” and “Av9Eng.” For the time parameter, the query 217 indicates a range that starts at 2018-February-1 12:00:00 am UTC and ends at 2018-February-28 12:00:00 am UTC. In other words, the query is for the distribution of observed data values for the tracked variable metric1 within the specified time range across the two identified browsers and location in Canada, without regard to time zone and particular web page.

Based on the query 217, the AQP 200 accesses the browser histogram register set 115 and the country histogram register set 205. Since the query 217 queries a time range (i.e., multiple time slices of the time-series dataset), the AQP 200 selects multiple histogram registers from each histogram register set. From the histogram register set 115, the AQP 200 selects each histogram register that maps to timeⱼ modulo n₁, where j is the value for each time slice in the time range. Depending upon how the time values were normalized and/or scaled when the sketches were created, the AQP 200 may pre-process the query 217 to normalize/scale the time values in the query 217. The modulo would then be applied to the normalized and/or scaled time values. Likewise, the AQP 200 would select multiple histogram registers from the histogram register set 205 based on timeⱼ modulo n₄.

After selecting the appropriate histogram registers for the queried time range, the AQP 200 then selects the appropriate histograms within the selected histogram registers based on the query parameters. Within the histogram register set 115, the AQP 200 has identified histogram registers 213 as corresponding to the queried time range. The AQP 200 identifies histograms 207 within the histogram registers 213 as mapping to the hash value generated from “Av8Eng”. The AQP 200 identifies histograms 209 within the histogram registers 213 as mapping to the hash value generated from “Av9Eng”. Within the histogram register set 205, the AQP 200 has identified histogram registers 215 as corresponding to the queried time range. The AQP 200 identifies histograms 211 within the histogram registers 215 as mapping to the hash value generated from “CA”.

To generate the approximate answer to the query 217, the AQP 200 combines the minimum bins of histograms across attributes that correspond to a same time slice. The AQP 200 selects the minimum of each bin across the histograms corresponding to a time slice ti from the histograms 207, 209, 211 to construct a combined minimum histogram 221. FIG. 2 also depicts the AQP 200 combining histograms corresponding to a time slice tⱼ across the histograms 207, 209, 211 by selecting the minimum bins to construct a combined minimum histogram 219.

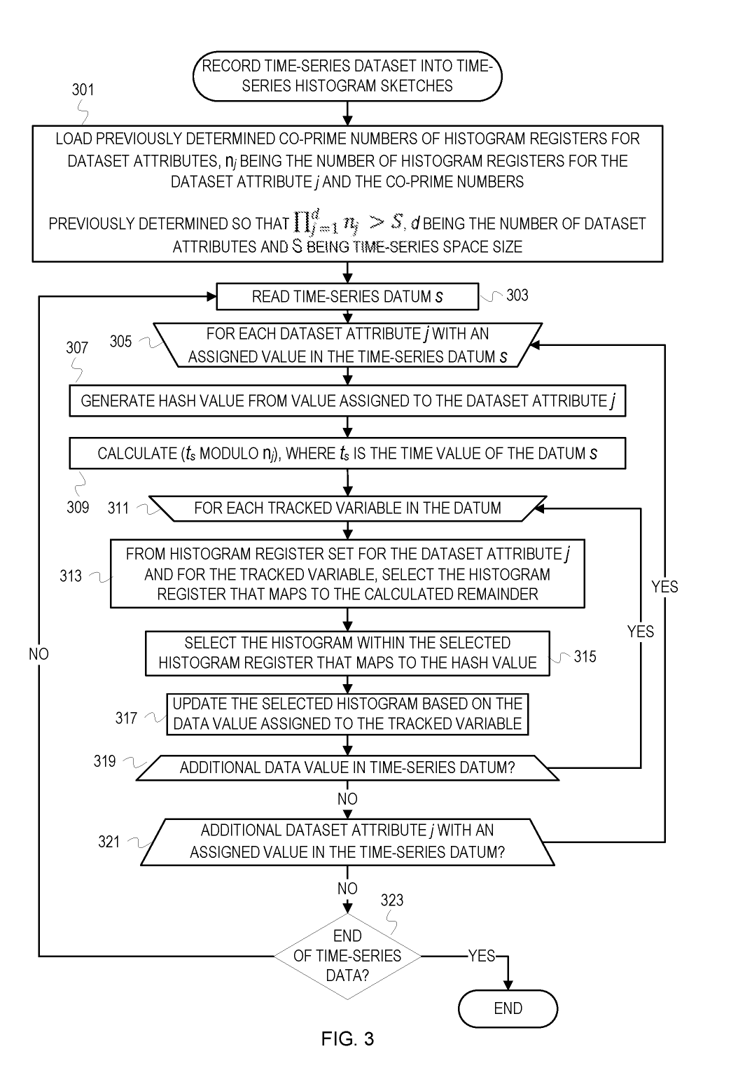

FIG. 3 is a flowchart of example operations for recording a time-series dataset into time-series histogram sketches. For consistency with FIG. 1, the description refers to a sketcher as performing the example operations. The description for FIG. 3 refers to each unit of the incoming time-series dataset as a time-series datum. While the example illustrated in FIG. 1 referred to a streaming time-series dataset, the time-series dataset is not necessarily streaming to the sketcher. For instance, a sketcher can ingest a historical time-series dataset that is not being actively collected.

Prior to reading in a time-series dataset, the sketcher loads previously determined co-prime numbers that define the number of histogram registers for the attributes of the dataset (301). As explained earlier, the sketcher selects co-prime numbers for d dataset attributes that are near a d^{th} root of S so that the product of these co-prime numbers is greater than S (Πⱼ₌₁^{d}nⱼ>S). The sketcher loads the co-prime numbers into low latency memory to efficiently access when determining mapping from time slices to histogram registers within a histogram register set.

The sketcher begins reading in the datums of the time-series dataset (303) and determining mapping values. Datums do not necessarily have values for every dataset attribute, so the sketcher parses the time-series datum to determine each dataset attribute indicated in the time-series dataset with an assigned value. For each dataset attribute j with an assigned value (305), the sketcher generates a hash value from the value assigned to the dataset attribute j (307). The hash value will be used to select a histogram within a histogram register of the histogram register set for the dataset attribute j. Although each attribute could be associated with a different hash function of a d-universal family of hash functions as in other sketching technology, it is not necessary for this time-series histogram sketching technology. The sketcher also calculates the remainder of a time value of the datum divided by the co-prime number assigned to the dataset attribute j (309). The remainder is used to map to the histogram register within the histogram register set of the dataset attribute j.

With these two mapping values that identify a histogram register for the time slice of the datum and the histogram within that histogram register, the sketcher updates an appropriate bin of the histogram for each tracked variable indicated in the datum (311). From the histogram register set for the dataset attribute j, the sketcher selects the histogram register that maps to the calculated remainder (313). The sketcher can maintain other identifying/mapping information that identifies a histogram register set by attribute label or name. Embodiments can implement the organization of histogram registers and histogram register sets differently. For instance, a key-value store can be maintained that uses a variable type or variable name of a tracked variable as a key and as the values first level nested key-value stores. For the first level nested key-value stores, the keys can be a dataset attribute label or name and the associated values second level nested key-value stores which correspond to the histogram register sets. For the second level nested key-values stores, they keys are time-based keys (e.g., 0 to nᵢ) and associated values third level nested key-values stores corresponding to the histogram registers. For the third level nested key-values stores, the keys are based on the values of the dataset attribute (e.g., hash value of the dataset attribute value) and associated values histograms that are updated based on the value observed for the tracked variable at the datum time slice. After selecting the histogram register set with the calculated remainder, the sketcher selects a histogram that maps to the hash value of the value assigned to the dataset attribute j in the datum (315). The sketcher then updates the selected histogram within the selected histogram register based on the data value assigned to the tracked variable within the datum (317). Bin selection for updating the histogram can vary by the tracked variable and particular implementation of the histogram.

After updating the selected histogram, the sketcher continues processing the other tracked variables indicated in the datum (319). After updating the histograms of the tracked variables within the selected histogram registers that correspond to the time slice of the datum and within the histogram register set of the dataset attribute j, the sketcher proceeds to process the other attributes indicated in the datum (321). If the sketcher does not reach the end of the time-series dataset (323), the sketcher proceeds to read the next time-series datum s. The sketcher can determine that it has reached the end of the time-series data based on an explicit end of file or end of stream, or detecting an expiration of a timeout. The “end” of the time-series dataset may be a temporary end (i.e., additional data will be collected).

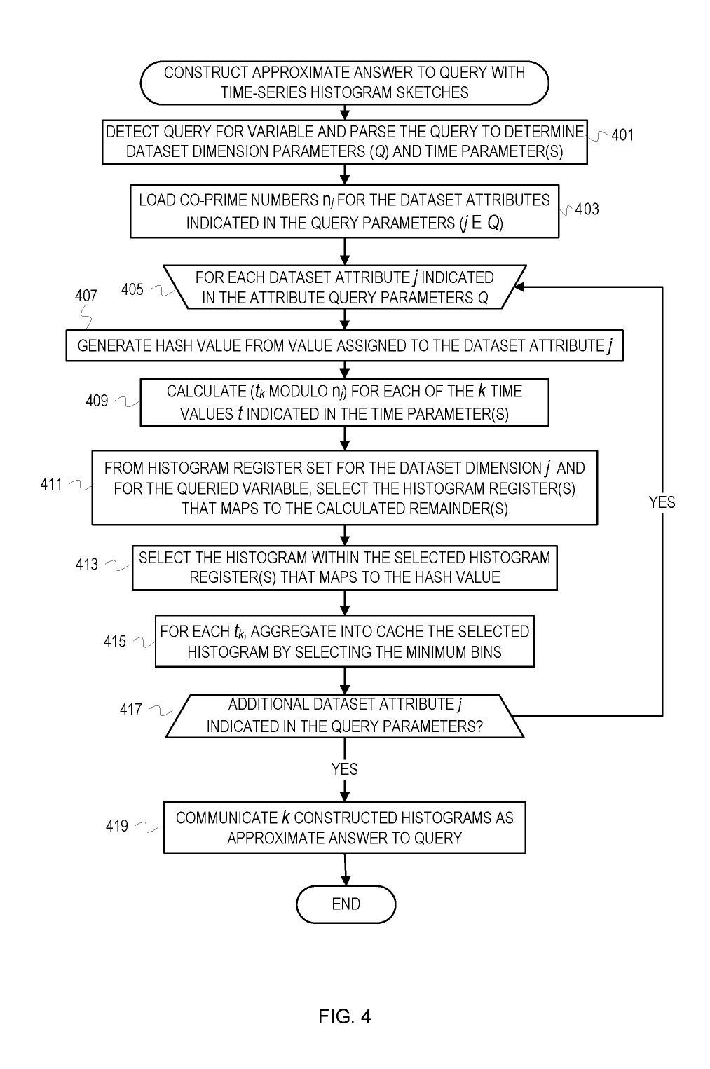

FIG. 4 is a flowchart of example operations for constructing an approximate answer to a query with time-series histogram sketches. For consistency with FIG. 2, the description of FIG. 4 refers to an AQP performing the operations. To construct an answer, the AQP uses the mapping established when recording the time-series dataset into the histogram registers and then construct a histogram by selecting the minimum bins across histograms of different attributes for a same time slice.

The AQP detects a query for a variable that has been tracked in time-series histogram sketches (401). The AQP parses the query to determine the dataset attribute parameters and the time parameter(s) indicated in the query. Since the query is on a time-series dataset, the query should have one or more time parameters that indicate one or more time values corresponding to time instants or time slices within the span of time of the time-series dataset.

If not already loaded to be available to the AQP, the AQP loads the co-prime numbers of the dataset attributes indicated in the query (403). If the AQP can be run for different time-series datasets, the AQP can access a listing or store of co-prime numbers organized by dataset identifier.

The AQP then determines iterates over each dataset attribute indicated in the attribute query parameters (j∈Q) to determine the mapping values and retrieve the appropriate histograms from the appropriate histogram registers (405). As with recording into the sketches, the AQP determines mapping values to identify the appropriate histogram register and histograms to construct the approximate answer to the query. The AQP generates a hash value from the value assigned to the dataset attribute j (407). The AQP then calculates the remainder(s) from dividing each time parameter indicated in the query by the co-prime number assigned to the dataset attribute j (tₖ modulo nⱼ), where there are k time values for the time parameter(s) indicated in the query (409). This yields the mapping values for each time slice corresponding to the time parameter(s) indicated in the query. From the collection of histogram register sets created for the tracked variable of the query, the AQP selects the histogram register(s) that maps to the calculated remainder(s) from the histogram register set of the dataset attribute j (411).

The AQP caches the histograms that are selected to cumulatively (or eventually) combine by minimum bin selection. Within each histogram register set that mapped to a calculated remainder, the AQP selects the histogram that maps to the hash value generated from the value assigned to the dataset attribute j (413). For each time slice tₖ for which a histogram register was selected, the AQP aggregates the selected histogram into cache with any other histogram corresponding to the time slice (415). The AQP can maintain a cache (or data structure in working memory) with an entry for each time slice indicated in the query. In each pass, the AQP can aggregate the selected histogram retrieved for a time slice with a histogram already in the entry for the time slice. The aggregation involves iterating over the bins of the histograms and choosing the minimum of each pair of bins. Embodiments can delay the aggregation until reading out all histograms. If there is an additional attribute indicated in the query (417), then the AQP proceeds with retrieving and aggregating the histograms of the time slice(s) indicated in the query for the next dataset attribute. Otherwise, the AQP communicates the k constructed minimum histograms as an approximate answer to the query (419).

Variations

The example illustrations describe an embodiment with multiple nested key-value stores (KVS) to store the time-series histogram sketches. An example is described with three levels of nesting that starts with an outermost key based on a tracked variable identifier. Embodiments can rearrange the nesting to use the dataset attribute labels as outermost keys and the tracked variable identifiers as keys for the first level nested KVS. Embodiments also do not necessarily need to use a single, multiple nested KVS. Embodiments can maintain separate nested KVSs for each tracked variable. Moreover, embodiments are not limited to using KVSs and can use different store or database technology.

The example illustrations describe examples that maintain histogram sketches for each tracked variable. Embodiments, however, can increase the degree of summarization by maintaining histogram sketches for tracked variables by type or by groups specified as similar. For example, a sketcher can be configured to use a histogram register set to track distribution of values over time for multiple different variables that relate to time (e.g., page load times for different pages or database access latency for different databases accessed by a monitored application).

The examples refer to several monikers for programs (e.g., sketcher, approximate query processor) that perform described functionality. These monikers are utilized since numerous implementations are possible due to different platforms, different programming languages, changing best programming practices, programmer preferences, etc. The terms allow for efficient explanation of the disclosure and are not intended to limit the scope of the claims.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 and FIG. 4 can be performed differently to iterate over dataset attribute and metric variables or query parameters in a different order than that depicted. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

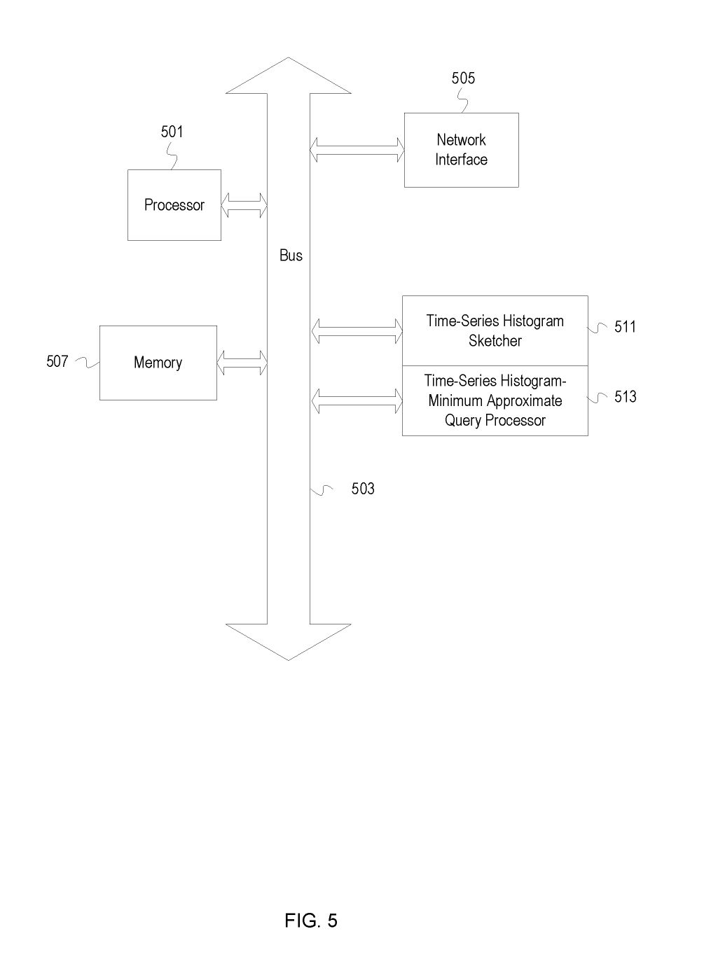

FIG. 5 depicts an example computer system with a time-series histogram sketcher and a time-series histogram-minimum approximate query processor. The computer system includes a processor 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a time-series histogram sketcher 511 and a time-series histogram-minimum approximate query processor 513. The sketcher 511 summarizes a time-series dataset by recording data values of each variable for which value distribution is to be tracked. The sketcher 511 records the distribution of data values into histograms organized into histogram registers by time slice and further organized into sets of histogram registers by dataset attribute. To answer a query on a tracked variable, the approximate query processor 513 selects a histogram register set of each dataset attribute indicated in a query and then selects one or more histogram registers within the selected histogram register based on the time parameter of the query. The timer-series dataset is summarized by allowing for data values assigned to a tracked variable from different data slices to be tracked in a same histogram based on the Chinese Remainder Theorem as described earlier. The approximate query processor 513 relies on mappings established by the sketcher 511 to retrieve histograms based on parameters in a query. The approximate query processor combines histograms across dataset attributes that correspond to a same time slice by minimum bin selection. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for generating histogram sketches from time-series data to facilitate efficient construction of approximate answers to queries on the time-series dataset as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining j co-prime numbers that have a product greater than S, wherein the j co-prime numbers correspond to j attributes of a time-series dataset and S is a time-based size of a time-series dataset; and
recording observed distribution of values of a first variable indicated in the time-series dataset into multiple sets of histogram sketches, wherein recording the observed distribution of values of the first variable into the multiple sets of histogram sketches comprises,
for each set of histogram sketches, calculating first remainders of time values divided by the co-prime number for the attribute corresponding to the set of histogram sketches, wherein the time values correspond to the observed values of the first variable within the time-series dataset and wherein each first calculated remainder maps to a histogram sketch within the set of histogram sketches; and
within each of the histogram sketches mapped from the first calculated remainders,
identifying a histogram in the histogram sketch based on an attribute value of the one of the attributes corresponding to the histogram sketch and associated with the value of the first variable observed at the one of the time values from which the remainder was calculated; and
updating the histogram based on the value of the first variable observed at the one of the time values from which the remainder was calculated.

2. The method of claim 1 further comprising:
based on detection of a query about the first variable of the time-series dataset, determining which of the attributes of the time-series dataset are indicated in the query and a time parameter indicated in the query;
retrieving from the multiple sets of histogram sketches a subset of histogram sketches based on the time parameter and the set of attributes indicated in the query to retrieve, wherein the retrieving comprises,
identifying those of the multiple sets of histogram sketches that correspond to the set of attributes indicated in the query;
calculating second remainders of a query time value divided by each of the co-prime numbers corresponding to the set of attributes, wherein the query time value is based, at least in part, on the time parameter and wherein each second calculated remainder maps to a histogram sketch within the set of histogram sketches corresponding to the attribute that corresponds to the co-prime number used as the divisor; and
selecting minimum bins across the subset of histogram sketches to construct a histogram of minimums, wherein the subset of histogram sketches is the histogram sketches mapped from the second remainders; and
returning the histogram of minimums as an answer to the query.

3. The method of claim 2 further comprising modifying the time parameter to generate the time value and modifying raw time values of the time-series dataset to generate the time values, wherein the modifying of the time parameter and the raw time values is based on S.

4. The method of claim 1, wherein determining the co-prime numbers comprises searching for j co-prime numbers that are near a j^{th} root of S.

5. The method of claim 4, wherein the each of the co-prime numbers corresponds to a different one of the attributes of the time-series dataset.

6. The method of claim 1 further comprising creating nⱼ histogram sketches for each of the j attributes, wherein nⱼ is the co-prime number of the j^{th} attribute.

7. The method of claim 1 further comprising creating the multiple sets of histogram sketches with nested key-value stores.

8. The method of claim 7, wherein an outermost key-value store uses keys based on labels of the attributes and first nested key-value stores as the values, wherein each first nested key-values store use as keys those of first remainders calculated with the co-prime number corresponding to the attribute corresponding to the key associated with the first-nested key value store, and the values of the first nested key-value stores are second nested key-value stores the values of which are histograms and keys of which are based on values assigned to the attributes.

9. The method of claim 1, wherein recording the observed distribution further comprises selecting each set of histogram sketches based on the attribute corresponding to the selected set of histogram sketches and a value assigned to the attribute being associated with one of the observed values of the first variable.

10. The method of claim 1, wherein identifying a histogram in the histogram sketch based on an attribute value of the one of the attributes comprises identifying the histogram based on a hash value generated from the attribute value.

11. The method of claim 1, wherein S corresponds to time slices in the time-series dataset.

12. One or more non-transitory machine-readable media comprising program code for time-series histogram sketching of time-series data, the program code comprising instructions to:
determine j co-prime numbers that have a product greater than S, wherein the j co-prime numbers correspond to j attributes of a time-series dataset and S is a time-based size of the time-series dataset; and
record observed distribution of values of a first variable indicated in the time-series dataset into multiple sets of histogram sketches, wherein the instructions to record the observed distribution of values of the first variable into the multiple sets of histogram sketches comprise instructions to,
for each set of histogram sketches, calculate first remainders of time values divided by the co-prime number for the attribute corresponding to the set of histogram sketches, wherein the time values correspond to the observed values of the first variable within the time-series dataset and wherein each first calculated remainder maps to a histogram sketch within the set of histogram sketches; and
within each of the histogram sketches mapped from the first calculated remainders,
identify a histogram in the histogram sketch based on an attribute value of the one of the attributes corresponding to the histogram sketch and associated with the value of the first variable observed at the one of the time values from which the remainder was calculated; and
update the histogram based on the value of the first variable observed at the one of the time values from which the remainder was calculated.

13. The non-transitory machine-readable media of claim 12, wherein the program code further comprises instructions to:
based on detection of a query about the first variable of the time-series dataset, determine which of the attributes of the time-series dataset are indicated in the query and a time parameter indicated in the query;
retrieve from the multiple sets of histogram sketches a subset of histogram sketches based on the time parameter and the set of attributes indicated in the query to retrieve, wherein the instructions to retrieve comprise instructions to,
identify those of the multiple sets of histogram sketches that correspond to the set of attributes indicated in the query;
calculate second remainders of a query time value divided by each of the co-prime numbers corresponding to the set of attributes, wherein the query time value is based, at least in part, on the time parameter and wherein each second calculated remainder maps to a histogram sketch within the set of histogram sketches corresponding to the attribute that corresponds to the co-prime number used as the divisor; and
select minimum bins across the subset of histogram sketches to construct a histogram of minimums, wherein the subset of histogram sketches is the histogram sketches mapped from the second remainders; and
return the histogram of minimums as an answer to the query.

14. The non-transitory machine-readable media of claim 12, wherein the instructions to determine the co-prime numbers comprise instructions to search for j co-prime numbers that are near a j^{th} root of S.

15. The non-transitory machine-readable media of claim 12, wherein the program code further comprises instructions to create nⱼ histogram sketches for each of the j attributes, wherein nⱼ is the co-prime number of the j^{th} attribute.

16. The non-transitory machine-readable media of claim 12, wherein the program code further comprises instructions to create the multiple sets of histogram sketches with nested key-value stores.

17. An apparatus comprising:
a processor; and
a machine-readable medium having instructions executable by the processor to cause the apparatus to,
determine j co-prime numbers that have a product greater than S, wherein the j co-prime numbers correspond to j attributes of a time-series dataset and S is a time-based size of the time-series dataset; and
record observed distribution of values of a first variable indicated in the time-series dataset into multiple sets of histogram sketches, wherein the instructions to record the observed distribution of values of the first variable into the multiple sets of histogram sketches comprise instructions to,
for each set of histogram sketches, calculate first remainders of time values divided by the co-prime number for the attribute corresponding to the set of histogram sketches, wherein the time values correspond to the observed values of the first variable within the time-series dataset and wherein each first calculated remainder maps to a histogram sketch within the set of histogram sketches; and
within each of the histogram sketches mapped from the first calculated remainders,
identify a histogram in the histogram sketch based on an attribute value of the one of the attributes corresponding to the histogram sketch and associated with the value of the first variable observed at the one of the time values from which the remainder was calculated; and
update the histogram based on the value of the first variable observed at the one of the time values from which the remainder was calculated.

18. The apparatus of claim 17, wherein the machine-readable medium further comprises instructions executable by the processor to cause the apparatus to:
based on detection of a query about the first variable of the time-series dataset, determine which of the attributes of the time-series dataset are indicated in the query and a time parameter indicated in the query;
retrieve from the multiple sets of histogram sketches a subset of histogram sketches based on the time parameter and the set of attributes indicated in the query to retrieve, wherein the instructions to retrieve comprise instructions to,
identify those of the multiple sets of histogram sketches that correspond to the set of attributes indicated in the query;
calculate second remainders of a query time value divided by each of the co-prime numbers corresponding to the set of attributes, wherein the query time value is based, at least in part, on the time parameter and wherein each second calculated remainder maps to a histogram sketch within the set of histogram sketches corresponding to the attribute that corresponds to the co-prime number used as the divisor; and
select minimum bins across the subset of histogram sketches to construct a histogram of minimums, wherein the subset of histogram sketches is the histogram sketches mapped from the second remainders; and
return the histogram of minimums as an answer to the query.

19. The apparatus of claim 17, wherein the instructions to determine the co-prime numbers comprise instructions executable by the processor to cause the apparatus to search for j co-prime numbers that are near a j^{th} root of S.

20. The apparatus of claim 17, wherein the machine-readable medium further comprises instructions executable by the processor to cause the apparatus to create nⱼ histogram sketches for each of the j attributes, wherein nⱼ is the co-prime number of the j^{th} attribute.
